(19) United States
(12) Patent Application Publication
(10) Pub. No.: US 2025/0379820 A1
(43) Pub. Date: Dec. 11, 2025

(54) ANALYZING NETWORK PERFORMANCE AT AN ADAPTIVE GRANULARITY

(71) Applicant: AT&T Intellectual Property I, L.P., Atlanta, GA (US)

(72) Inventors: Sridhar Narahari, Milpitas, CA (US); Junping Zhang, Freehold, NJ (US)

(21) Appl. No.: 18/735,131

(22) Filed: Jun. 5, 2024

(51) Int. Cl. H04L 47/122; H04L 47/10; H04L 47/625

(52) U.S. Cl. CPC H04L 47/122; H04L 43/0829; H04L 47/29

(57) ABSTRACT

A method performed by a processing system including at least one processor includes monitoring network traffic at a location in a communications network according to a first granularity, determining that a condition has been detected that indicates a likelihood of degradation of network performance at the location being monitored, beginning to monitor the network traffic at the location according to a second granularity that is more granular than the first granularity, determining, based on the monitoring according to the second granularity, a determined network performance, and adjusting, in response to the determined network performance, a manner in which the network traffic at the location is steered through the communications network.

The present disclosure relates generally to communications networks and relates more particularly to devices, non-transitory computer-readable media, and methods for analyzing network performance at an adaptive granularity in response to the detection of events that may signal performance degradation.

### BACKGROUND

Enterprise networking solutions may use one or both of two approaches to measure network performance for a wide area network (WAN) link or site. A first approach measures the performance of the WAN link or site for actual network traffic (e.g., actual data packets or traffic flows observed traversing the WAN link or site). A second approach avoids measuring actual network traffic, and instead uses active probes (e.g., Internet control message protocol (ICMP) probes, hypertext transfer protocol (HTTP) probes, or the like) to produce a general measure of network performance based on synthetic network traffic. Either of these approaches may be performed at varying levels of granularity (e.g., per data packet, per data flow, per session, per link, etc.).

### SUMMARY

In one example, the present disclosure describes a device, computer-readable medium, and method for analyzing network performance at an adaptive granularity in response to the detection of events that may signal performance degradation. For instance, in one example, a method performed by a processing system including at least one processor includes monitoring network traffic at a location in a communications network according to a first granularity, determining that a condition has been detected that indicates a likelihood of degradation of network performance at the location being monitored, beginning to monitor the network traffic at the location according to a second granularity that is more granular than the first granularity, determining, based on the monitoring according to the second granularity, a determined network performance, and adjusting, in response to the determined network performance, a manner in which the network traffic at the location is steered through the communications network.

In another example, a non-transitory computer-readable medium stores instructions which, when executed by a processor, cause the processor to perform operations. The operations include monitoring network traffic at a location in a communications network according to a first granularity, determining, that a condition has been detected that indicates a likelihood of degradation of network performance at the location being monitored, beginning to monitor the network traffic at the location according to a second granularity that is more granular than the first granularity, determining, based on the monitoring according to the second granularity, a determined network performance, and adjusting, in response to the determined network performance, a manner in which the network traffic at the location is steered through the communications network.

In another example, a device includes a processor and a computer-readable medium storing instructions which, when executed by the processor, cause the processor to perform operations. The operations include monitoring network traffic at a location in a communications network according to a first granularity, determining that a condition has been detected that indicates a likelihood of degradation of network performance at the location being monitored, beginning to monitor the network traffic at the location according to a second granularity that is more granular than the first granularity, determining, based on the monitoring according to the second granularity, a determined network performance, and adjusting, in response to the determined network performance that is determined, a manner in which the network traffic at the location is steered through the communications network.

### BRIEF DESCRIPTION OF THE DRAWINGS

The teachings of the present disclosure can be readily understood by considering the following detailed description in conjunction with the accompanying drawings, in which:

FIG. 1 illustrates an example network, or system, in which examples of the present disclosure may operate;

FIG. 2 illustrates a flowchart of an example method for analyzing network performance at an adaptive granularity, in accordance with the present disclosure; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure analyzes network performance at an adaptive granularity in response to the detection of events that may signal performance degradation. As discussed above, enterprise networking solutions may use one or both of two approaches to measure network performance for a wide area network (WAN) link or site. A first approach measures the performance of the WAN link or site for actual network traffic (e.g., actual data packets or traffic flows observed traversing the WAN link or site). A second approach avoids measuring actual network traffic, and instead uses active probes (e.g., Internet control message protocol (ICMP) probes, hypertext transfer protocol (HTTP) probes, or the like) to produce a general measure of network performance based on synthetic network traffic. Either of these approaches may be performed at varying levels of granularity (e.g., per data packet, per data flow, per session, per link, etc.).

The first approach requires expensive equipment to be installed at customer premises for the purposes of monitoring network traffic associated with the customer premises. Installation of this equipment may not always be possible or feasible, especially for customers who are sensitive to costs. While the second approach is more cost effective, the more generalized results generated by this approach do not typically allow for more granular (e.g., data packet- or flow-level) decisions on prioritization and steering to be made on-demand.

Examples of the present disclosure provide an adaptive approach that adjusts the granularity with which the performance of an enterprise network is analyzed, in response to the detection of events which may signal a degradation in performance. For instance, in one example, the network traffic at a network location (e.g., link or site) may be monitored according to a first granularity, where granularity may refer to a frequency of the monitoring (e.g., every x packets or flows), a resolution of the monitoring (e.g., per-session versus per-link), or both the frequency and the resolution of the monitoring. If, in the course of monitoring the network traffic according to the first granularity, a triggering condition that signals a possible degradation in performance is detected, then the network traffic at the network location may be at least temporarily monitored according to a second granularity that is more granular or finer than the first granularity (e.g., every y seconds instead of every x seconds, where y<x, or per-session instead of per-link).

Advantages of the present disclosure include the ability to maintain a desired level of network performance while making more efficient use of the resources used to monitor network performance. By limiting the more granular (and more resource-intensive) examination of network traffic to times in which a possible degradation of performance is signaled, network resources can be conserved for when they are most needed, without sacrificing network performance. Moreover, by utilizing the disclosed approach, even more resource-constrained devices may be able to effectively monitor network performance.

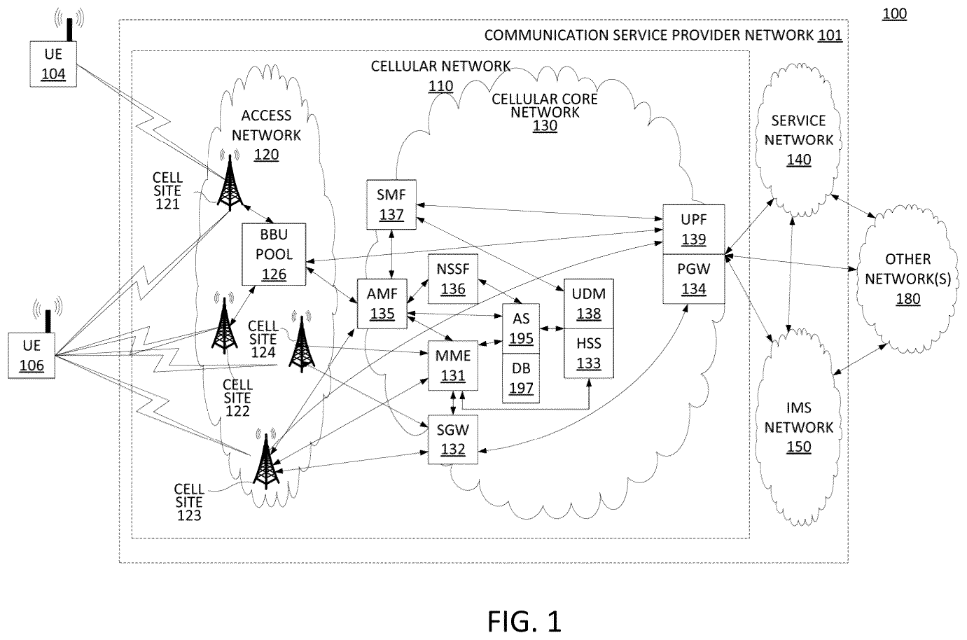

Examples of the present disclosure may extend to advanced network resiliency solutions (e.g., similar to software defined WAN, or SD-WAN, style solutions and other software defined networking solutions) for new classes of thinner devices that do not currently support such advanced functionality. Moreover, although examples of the present disclosure are discussed within the example contexts of SD-WAN and wireless networks (e.g., long term evolution, Fourth Generation, Fifth Generation cellular networks and/or 6G and future generations of cellular networks), it will be appreciated that the examples disclosed herein may be extended to wireline networks (including, for instance, broadband networks such as fiber optic and cable networks). These and other aspects of the present disclosure are discussed in greater detail in connection with FIGS. 1-3, below.

FIG. 1 illustrates an example network, or system, 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a radio access network (RAN), such as a cloud RAN, a distributed RAN (D-RAN), a centralized RAN (C-RAN), a virtualized RAN (V-RAN), or an open RAN (O-RAN). For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as MIMO antennas, and millimeter wave antennas.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU). In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU.

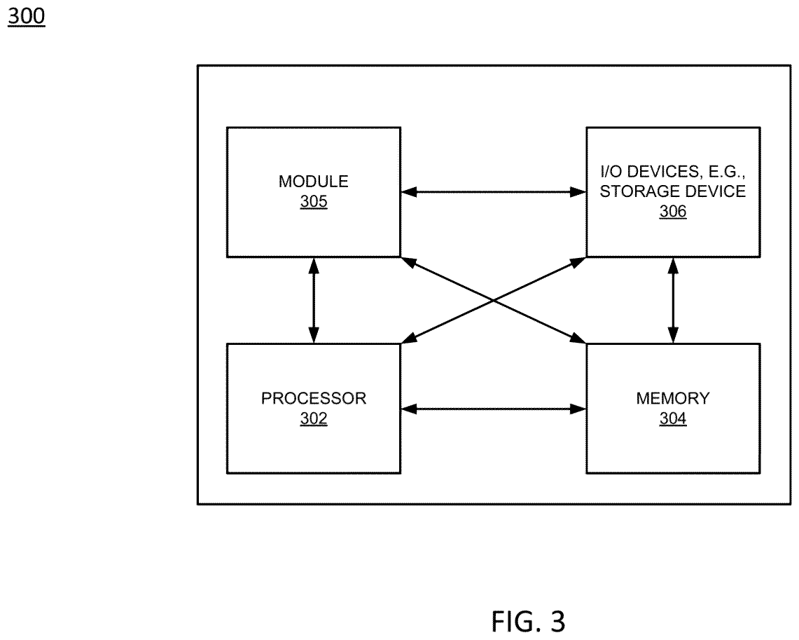

In accordance with the present disclosure, any one or more of cell sites 121-123 may be deployed with antenna and radio infrastructures, including MIMO and millimeter wave antennas. Furthermore, in accordance with the present disclosure, a base station (e.g., cell sites 121-123 and/or baseband units within BBU pool 126) may comprise all or a portion of a computing system, such as computing system 300 as depicted in FIG. 3, and may be configured to perform steps, functions, and/or operations in connection with examples of the present disclosure for analyzing network performance at an adaptive granularity.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network nodes such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 5G network components, 3G network components, etc. Thus, cellular core network 130 may comprise an integrated network, e.g., including any two or more of 2G-5G infrastructures and technologies (or any future infrastructures and technologies to be deployed, e.g., 6G), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QOS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., a “5GC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and/or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1. It should be noted that intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., user equipment (UE) 104 and 106. Each of the UEs 104 and 106 may comprise a cellular telephone, a smartphone, a tablet computing device, a laptop computer, a pair of computing glasses, a wireless enabled wristwatch, a wireless transceiver for a fixed wireless broadband (FWB) deployment, an item of customer premises equipment, or any other cellular-capable mobile telephony and computing device (broadly, “an endpoint device”). For instance, each of the UEs 104 and 106 may include one or more radio frequency (RF) transceivers for cellular communications and/or for non-cellular wireless communications. In one example, each of the UEs 104 and 106 may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals.

In one example, each of the UEs 104 and 106 may comprise all or a portion of a computing system, such as computing system 300 depicted in FIG. 3, and may be configured to perform steps, functions, and/or operations in connection with examples of the present disclosure for analyzing network performance at an adaptive granularity. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

As illustrated in FIG. 1, UE 104 may access wireless services via the cell site 121 (e.g., NR alone, where cell site 121 comprises a gNB), while UE 106 may access wireless services via any of the cell sites 121-124 located in the access network 120 (e.g., for NR non-dual connectivity, for LTE non-dual connectivity, for NR-NR DC, for LTE-LTE DC, for EN-DC, and/or for NE-DC). For instance, in one example, UE 106 may establish and maintain connections to the cellular core network 130 via one or multiple gNBs (e.g., cell sites 121 and 122 and/or cell sites 121 and 122 in conjunction with BBU pool 126 and/or various other components, such as a CU and/or a DU). In another example, UE 106 may establish and maintain connections to the cellular core network 130 via a gNB (e.g., cell site 122 and/or cell site 122 in conjunction with BBU pool 126) and an eNodeB (e.g., cell site 124), respectively. In addition, either the gNB or the eNodeB may comprise a PCell, and the other may comprise a SCell for carrier aggregation and/or dual connectivity. Similarly, UE 106 may communicate with any of the cell sites 121 and 122 using carrier aggregation (CA) (e.g., in accordance with a CA technique). Furthermore, either or both of NR/5G and or EPC (4G/LTE) core network components may manage the communications between UE 106 and the cellular network 110 via cell site 122 and cell site 124.

In one example, the cellular core network 130 may further include an application server (AS) 195, which may comprise a computing system or server, such as computing system 300 depicted in FIG. 3, and may be configured to provide one or more operations or functions in connection with examples of the present disclosure for analyzing network performance at an adaptive granularity. The cellular core network 130 may also include a database (DB) 197 that is communicatively coupled to the AS 195.

The AS 195 may comprise one or more physical devices, e.g., one or more computing systems or servers, such as computing system 300 depicted in FIG. 3, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, the AS 195 may be configured to analyze network performance at an adaptive granularity in response to the detection of events that may signal performance degradation. For instance, in some examples, the AS 195 may intercept and analyze network traffic (e.g., data packets and/or data flows) traversing a location associated with any of the UEs 104 or 106 or other customer premises equipment (CPE) within the communication service provider network 101. The AS 195 may further calculate a measure of the performance of the communication service provider network 101 at the location associated with the UE 104 or 106 or other CPE, based on data extracted from the intercepted network traffic. In one example, the granularity with which the AS 195 intercepts and extracts data from the network traffic (e.g., every n number of data packets or data flows, or per-session versus per-link) may be adjusted by the AS 195 in response to the presence or absence of conditions that may indicate a degradation of the network performance. For instance, the AS 109 may intercept and analyze the network traffic with greater granularity when conditions indicate a possible degradation in network performance and may intercept and analyze the network traffic with less granularity when conditions do not indicate a possible degradation in network performance.

In one example, the AS 195 may be further configured to analyze multimodal signals from the UEs 104 and 106 and other network elements (e.g., cell sites 121, 122, 123, and 124 or elements of the cellular core network 130), where the AS 195 may infer a possible degradation in network performance from the multimodal signals. In one example, the multimodal signals may be “multimodal” in the sense that the signals may contain different types of information or alerts generated by different types of devices. For instance, the multimodal signals may include a signal (e.g., provided via application integration) that indicates that a software application being used by a UE 104 or 106 is not performing as expected, a notification generated by a UE 104 or 106 that indicates that the UE 104 or 106 is malfunctioning, a notification from the UE 104 or 106 or from an element in the cellular core network 130 reporting an observation of a packet queue containing a number of packets that is greater than a threshold number of packets (where a queue containing a number of packets that is greater than the threshold number may indicate link congestion), a notification from the UE 104 or 106 reporting a bandwidth utilization that falls outside of a predefined bandwidth utilization range, a notification generated by cell site 121, 122, 123, or 124 reporting the detection of a pattern in the network traffic that is known to be associated with a degradation in network performance (e.g., a pattern that is a signature for a particular type of network intrusion, attack or failure condition), or another type of signal. In a further example, the multimodal signals may include tickets and/or documentation of incidents reported by users of the communication service provider network 101 or a change (e.g., increase) in the number or rate of degradation incidents being reported by users that relate to a specific device, location, area, or region. For instance, if the aggregate number of tickets pertaining to a specific device, location, area, or region exceeds a threshold number of tickets, or experiences a rate of increase (e.g., number of tickets per unit of time) that exceeds a threshold rate of increase, this may indicate a need for more granular performance monitoring for the specific device, location, area, or region.

As discussed above, the AS 195 may intercept and analyze the network traffic more frequently when conditions indicate a possible degradation in network performance and may intercept and analyze the network traffic less frequently when conditions do not indicate a possible degradation in network performance. In one example, the AS 195 may employ a machine learning model that predicts a likelihood of a degradation in network performance (e.g., an ongoing or worsening degradation or an imminent degradation) in response to observed characteristics of the intercepted network traffic and/or multimodal signals. When the machine learning model predicts that the likelihood of a degradation in network performance is high (e.g., above a predefined threshold likelihood), the AS 195 may take an action to adjust the steering of the network traffic at the location (e.g., so that the network traffic to and/or from the location is re-routed over one or more alternate links that are expected to provide improved network performance).

In this example, the DB 197 may store information about thresholds against which the multimodal signals and/or metrics computed from the intercepted network traffic may be compared. The thresholds may vary by location. That is, a threshold for a first location in the communication service provider network 101 may be different from a threshold for a second location in the communication service provider network 101. For instance, for each location to be monitored, the DB 197 may store an expected bandwidth utilization range, a maximum or threshold number of packets that can be contained within a queue length, a maximum latency threshold, a minimum bandwidth threshold, and/or another type of threshold.

In a further example, the DB 197 may store information about the topology of the communication service provider network including network elements, links between network elements, and metrics indicating the respective performances of the network elements and links (which may be periodically updated). Thus, the data stored in the DB 197 may be updated when network elements are added to or removed from the communication service provider network 101, when existing network elements are moved within the communication service provider network 101, and when new connections between network elements are established or existing connections between network elements are removed.

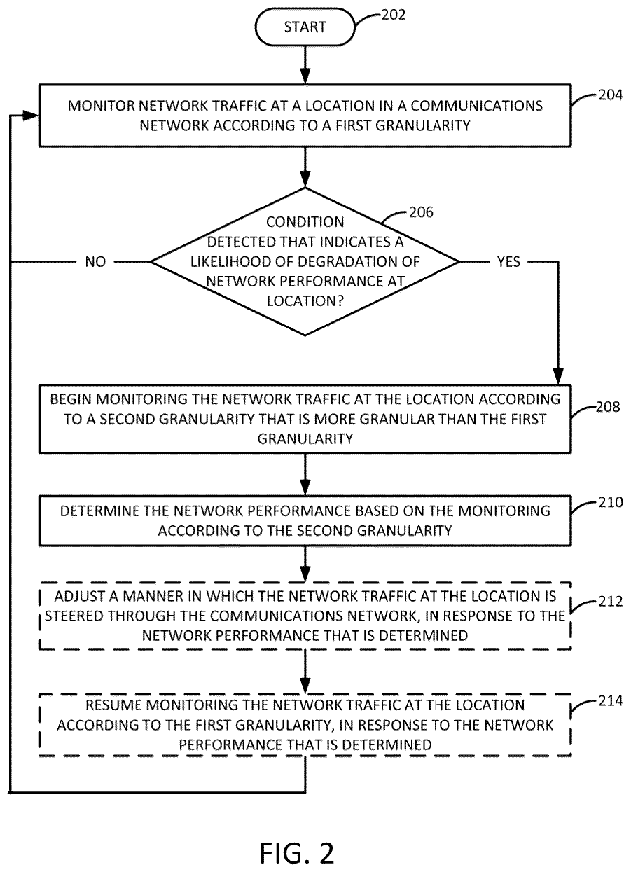

In one example, the DB 197 may comprise a physical storage device integrated with the AS 195 (e.g., a database server or a file server), or attached or coupled to the AS 195, in accordance with the present disclosure. In one example, the AS 195 may load instructions into a memory, or one or more distributed memory units, and execute the instructions for analyzing network performance at an adaptive granularity in response to the detection of events that may signal performance degradation, as described herein. An example method for analyzing network performance at an adaptive granularity is described in greater detail below in connection with FIG. 2.

In one example, the cellular core network 130 may include multiple instances of the AS 195 and DB 197 distributed throughout the cellular core network 130, where the multiple instances each store identical data for the purposes of redundancy.

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of the cell sites 121-123 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. Thus, these and other modifications are all contemplated within the scope of the present disclosure.

To further aid in understanding the present disclosure, FIG. 2 illustrates a flowchart of an example method 200 for analyzing network performance at an adaptive granularity, in accordance with the present disclosure. In one example, the method 200 may be performed by an application server that is configured to analyze the performance of a communications network, detect degradations in the performance, and initiate remedial measures in response to the degradations, such as the AS 195 illustrated in FIG. 1. However, in other examples, the method 200 may be performed by another device, such as the processor 302 of the system 300 illustrated in FIG. 3. For the sake of example, the method 200 is described as being performed by a processing system.

The method 200 begins in step 202. In step 204, the processing system may monitor network traffic at a location in a communications network according to a first granularity.

In one example, the communications network may comprise a cellular network operated by a cellular network service provider. The location may comprise a device, a link, a path (e.g., a series of links), a data flow (e.g., a data packet flow or a session flow), a wide area network (WAN), or a site within the communications network. The link, WAN, or site may be part of a customer premises (e.g., a location from which a customer of the cellular network service provider accesses the cellular network). In a further example, the location may be a larger (e.g., regional) physical location, such as a campus, a city, a county, a state or province, or the like. In one example, the performance of the communications network (e.g., in terms of latency, bandwidth, packet loss, and/or other metrics) may be monitored at the location as part of a subscription service or a service level agreement that guarantees some defined minimum level of performance.

In one example, monitoring the network traffic may include collecting a number of data packets and/or data flows that traverse the location and inspecting the collected data packets and/or data flows for signs that may indicate a degradation in network performance. The first granularity may in this case comprise a frequency with which data packets or data flows are collected from the network traffic for further inspection and/or a resolution with which the data packets or data flows are collected. For instance, the first granularity may cause the processing system to collect every x data packet or every x data flow that traverses the location for further inspection, or may cause the processing system to collect data packets or data flows for each session associated with the location. In another example, monitoring the network traffic may include collecting statistics about the data packets and/or data flows that traverse the location, without collecting the data packets and/or data flows themselves. For instance, the first granularity may cause the processing system to collect the statistics for all traffic, per-application, per flow or session, or with a different level of granularity.

In one example, the monitoring in step 204 may further involve monitoring multimodal signals that may be received from various devices in the communications network, including devices at the location, where the multimodal signals may contain data other than (i.e., separate from) network traffic. That is, the network traffic that is collected by the processing system according to the first granularity may include traffic for which the processing system is neither the source nor the destination. However, the processing system may be the intended destination for the multimodal signals, which contain data that is explicitly meant to assist the processing system in detecting degradations in network performance. The multimodal signals may include, for example, resource utilization metrics from devices at the location, logs (e.g., error logs, event logs, security logs, or the like) from devices at the location, and/or other types of signals. Machine learning and/or deep learning algorithms (e.g., neural networks, support vector machines, random forest algorithms, naïve Bayes algorithms, linear regression algorithms, decision trees, or any other type of machine learning techniques) may be used to learn the types of signals which are most likely to indicate potentially problematic conditions that may require more granular monitoring. Such machine learning and/or deep learning algorithms may therefore be used to learn multimodal signals that should be monitored in addition to the multimodal signals explicitly listed here.

The multimodal signals may not be monitored at the same granularity as the network traffic. For instance, multimodal signals may be generated by the devices and sent to the processing system on an event-based basis (e.g., in response to the occurrence of a predefined event, such as a device resource utilization exceeding a threshold). Multimodal signals could also be generated by the devices and sent to the processing system on a periodic or scheduled basis (e.g., every s seconds, every m minutes, etc.) that is more or less granular that the granularity with which the network traffic is monitored.

In step 206, the processing system may determine whether a condition has been detected as a result of the monitoring that indicates a likelihood of degradation of network performance at the location being monitored. In one example, a condition that indicates a likelihood of degradation of network performance at the location being monitored may include one or more of: evidence that a software application being used by a user at the location is not performing as expected (which could be inferred from a signal provided to the processing system via application integration), evidence that a network-connected device at the customer premises is malfunctioning (which may be inferred from a notification generated by the network-connected device), a packet queue containing a number of packets that is greater than a threshold number of packets (where the threshold number may be an average of a number of historically observed packet queues; in this case, a packet queue containing a number of packets that is greater than the threshold number may indicate link congestion and evidence of the number of packets contained in the queue may be provided to the processing system via a device at the location), a bandwidth utilization that falls outside of a predefined bandwidth utilization range (e.g., bandwidth utilization that is higher or lower than the bandwidth utilization range, where the bandwidth utilization range may be based on historically observed bandwidth utilization at the location), the presence of a pattern in the network traffic that is known to be associated with a degradation in network performance (e.g., a pattern that is a signature for a particular type of network intrusion, attack or failure condition), or another condition.

In one example, machine learning techniques may be used to analyze collected network traffic (e.g., data packets and/or data flows) and/or multimodal signals and to determine whether characteristics of the collected network traffic and/or multimodal signals are likely to indicate a degradation in network performance. For instance, a machine learning model could be trained to take as input one or more characteristics of the collected network traffic and/or one or more types of multimodal signals and to generate as an output a likelihood (e.g., a probability score) that a degradation in network performance has occurred, is worsening, or is about to occur. In one example, machine learning techniques that could be used to generate the likelihood may include a neural network, a support vector machine, a random forest algorithm, a naïve Bayes algorithm, a linear regression algorithm, a decision tree, or any other type of machine learning techniques.

If the processing system concludes in step 206 that a condition that indicates a likelihood of degradation of network performance at the location being monitored has not been detected, then the method 200 may return to step 204, and the processing system may continue to monitor network traffic at the location according to the first granularity. If, however, the processing system concludes in step 206 that a condition that indicates a likelihood of degradation of network performance at the location being monitored has been detected, then the method 200 may proceed to step 208.

In step 208, the processing system may begin monitoring the network traffic at the location according to a second granularity that is more granular than the first granularity. For instance, if the first granularity caused the processing system to collect every x data packet or every x data flow that traverses the location for further inspection, then the second granularity might cause the processing system to collect every y data packet or every y data flow that traverses the location for further inspection, where y<x. Alternatively, if the first granularity caused the processing system to collect data packets or data flows for every link associated with the location, then the second granularity might cause the processing system to collect data packets or data flows for every session associated with the location. In other words, the processing will begin to collect network traffic with greater granularity in step 208. This will provide the processing system with a view of the network conditions at a finer granularity than was available when the processing system was collecting network traffic according to the first granularity.

As in step 204, the monitoring in step 208 may further involve monitoring multimodal signals that may be received from various devices in the communications network, including devices at the location, where the multimodal signals may contain data other than network traffic.

In another example, the granularity or granularity of the monitoring may be increased for less than all of the network traffic at the location. That is, although the monitoring could be performed according to the second granularity for all network traffic at the location, the monitoring according to the second granularity could alternatively be performed for a subset of the network traffic at the location (e.g., network traffic at the location that is associated with a specific type or types of software application, network traffic at the location that belongs to specific data flows or sessions, or the like), while the processing system may continue to monitor any network traffic at the location that is not part of the subset of the network traffic according to the first granularity.

In step 210, the processing system may determine the network performance based on the monitoring according to the second granularity. For instance, the processing system may calculate a performance metric that is based on a combination of measurements (e.g., key performance indicators) of the network traffic that is collected while the monitoring is being performed according to the second granularity. This performance metric (e.g., a determined performance metric) may be calculated in any one or more of a number of known ways and may be based on any one or more measurements, such as latency, bandwidth, packet loss, and/or the like. The calculation of the performance metric may also account for data in the multimodal signals. Alternatively, the determined network performance may be based on a single measurement or key performance indicator that is considered most critical for the location or for the customer(s) associated with the location.

In optional step 212 (illustrated in phantom), the processing system may adjust a manner in which the network traffic at the location is steered through the communications network, in response to the network performance that is determined. For instance, if the network performance determined in step 210 is poor (e.g., the performance metric is near or below a threshold minimum performance metric), then the processing system may adjust the manner in which the network traffic at the location is steered. For instance, the processing system may reroute the network traffic at the location over a new network link (or set of links) that is expected to provide better performance (e.g., lower latency, greater bandwidth, etc.) for the network traffic.

In optional step 214 (illustrated in phantom), the processing system may resume monitoring the network traffic at the location according to the first granularity, in response to the network performance that is determined. For instance, if the network performance determined in step 210 is acceptable (e.g., the performance metric is currently above a threshold minimum performance metric), then the processing system may conclude that it is currently unnecessary to monitor the network traffic at the finer level of granularity provided by the second granularity. As an example, the condition detected in step 206 may comprise an anomaly or a false alarm that has little impact on the network performance or has only a fleeting impact on the network performance (e.g., a limited time based crowd sourcing event such as real time voting by viewers of a live broadcasted performance, and the like).

Alternatively, if the processing system determines that monitoring according to the second granularity is consuming more than a permitted threshold amount of resources, then the processing system may dynamically scale the monitoring back to a granularity that is less granular than the second granularity. In one example, the network monitoring may continue at a third granularity that is neither the first granularity nor the second granularity. For instance, the third granularity may be less granular than the second granularity, but more granular than the first granularity (or even less granular than the first granularity, if appropriate or deemed necessary such as limited network resources). In one example, more than two different granularities may be available for monitoring the network traffic, and the processing system may choose the appropriate granularity at any time based on resource consumption considerations and/or network performance.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, an application server (such as might be used to perform the method 200) could be implemented as illustrated in FIG. 3.

As depicted in FIG. 3, the system 300 comprises a hardware processor element 302, a memory 304, a module 305 for analyzing network performance at an adaptive granularity, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for analyzing network performance at an adaptive granularity may include circuitry and/or logic for adjusting a granularity with which data packets and/or data flows are collected from network traffic and analyzed to determine network performance. The input/output devices 306 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for analyzing network performance at an adaptive granularity (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for analyzing network performance at an adaptive granularity (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
monitoring, by a processing system including at least one processor, network traffic at a location in a communications network according to a first granularity;
determining, by the processing system, that a condition has been detected that indicates a likelihood of degradation of network performance at the location being monitored;
beginning, by the processing system, to monitor the network traffic at the location according to a second granularity that is more granular than the first granularity;
determining, by the processing system based on the monitoring according to the second granularity, a determined network performance; and
adjusting, by the processing system in response to the determined network performance, a manner in which the network traffic at the location is steered through the communications network.

2. The method of claim 1, wherein the location is at least one of: a link within the communications network, a wide area network within the communications network, or a site within the communications network.

3. The method of claim 1, wherein the location is at least one of: a campus, a city, a county, a state, or a province.

4. The method of claim 1, wherein the first granularity defines at least one of: a frequency with which data packets are collected from the network traffic for further inspection, or a frequency with which data flows are collected from the network traffic for further inspection.

5. The method of claim 1, wherein the monitoring at the first granularity further comprises monitoring multimodal signals received from at least one device in the communications network, wherein the multimodal signals contain data other than the network traffic, and wherein the determining that the condition has been detected occurs as a result of the monitoring the multimodal signals.

6. The method of claim 5, wherein the multimodal signals include at least one of: a resource utilization metric from the at least one device, a log from the at least one device, a change in a number of incidents being reported by users of the at least one device, or a change in a rate of incidents being reported by users of the at least one device.

7. The method of claim 5, wherein the multimodal signals are sent by the at least one device with a granularity that is different from the first granularity.

8. The method of claim 5, wherein the condition comprises a software application being used by a user at the location that is not performing as expected.

9. The method of claim 8, wherein the condition is inferred from a multimodal signal of the multimodal signals that is provided to the processing system via application integration.

10. The method of claim 5, wherein the condition comprises a malfunction of the at least one device.

11. The method of claim 10, wherein the condition is inferred from a multimodal signal of the multimodal signals that comprises a notification generated by the at least one device.

12. The method of claim 5, wherein the condition comprises congestion in the communications network.

13. The method of claim 12, wherein the condition is inferred from a subset of the multimodal signals that indicates an existence of a packet queue containing a number of packets that is greater than a threshold number.

14. The method of claim 5, wherein the condition is inferred from a multimodal signal of the multimodal signals that indicates a bandwidth utilization that falls outside of a predefined bandwidth utilization range.

15. The method of claim 1, wherein the condition is inferred from a presence of a pattern in the network traffic that is known to be associated with the degradation in network performance.

16. The method of claim 1, wherein the determining is performed by executing a machine learning model that is trained to take as input at least one characteristic of the network traffic and to generate as an output a likelihood that the degradation in network performance has occurred.

17. The method of claim 1, wherein the determining calculates a performance metric that is based on a combination of the network traffic that is collected while the monitoring is being performed according to the second granularity.

18. The method of claim 1, further comprising:
resuming, by the processing system, the monitoring the network traffic at the location according to the first granularity, subsequent to the adjusting.

19. A non-transitory computer-readable medium storing instructions which, when executed by a processing system including at least one processor, cause the processing system to perform operations, the operations comprising:
monitoring network traffic at a location in a communications network according to a first granularity;
determining that a condition has been detected that indicates a likelihood of degradation of network performance at the location being monitored;
beginning to monitor the network traffic at the location according to a second granularity that is more granular than the first granularity;
determining, based on the monitoring according to the second granularity, a determined network performance; and
adjusting, in response to the determined network performance, a manner in which the network traffic at the location is steered through the communications network.

20. A device comprising:
a processing system including at least one processor; and
a computer-readable medium storing instructions which, when executed by the processing system, cause the processing system to perform operations, the operations comprising:
monitoring network traffic at a location in a communications network according to a first granularity;
determining that a condition has been detected that indicates a likelihood of degradation of network performance at the location being monitored;
beginning to monitor the network traffic at the location according to a second granularity that is more granular than the first granularity;
determining, based on the monitoring according to the second granularity, a determined network performance; and
adjusting, by the processing system in response to the determined network performance, a manner in which the network traffic at the location is steered through the communications network.
